(19) United States
(12) Patent Application Publication
(10) Pub. No.: US 2012/0151934 A1
(43) Pub. Date: Jun. 21, 2012

(54) RECUPERATOR WITH WIRE MESH

(75) Inventors: Anatoli Borissov, Sugar Land, TX (US); Vladimir Shtern, Houston, TX (US)

(73) Assignee: General Vortex Energy, Inc., Missouri City, TX (US)

(21) Appl. No.: 13/329,896

(22) Filed: Dec. 19, 2011

Related U.S. Application Data
(60) Provisional application No. 61/424,487, filed on Dec. 17, 2010.

(51) Int. Cl. F02C 1/00; F02C 7/10

(52) U.S. Cl. 60/772; 60/39.511

(57) ABSTRACT

A recuperator for use in transferring heat from gas turbine exhaust gases to compressed air inlet gases before combustion. The recuperator utilizes a plurality of planar or curved layers filled with metal wire mesh and bounded by thin metal sheets to form a heat exchanger having high effectiveness, low weight, and low pressure drop. The use of wire is a unique feature of the recuperator that makes it significantly low-cost compared with the prior art. Accordingly, the recuperator presented herein may be incorporated into a micro- or mini-turbine system for electric power generation or for developing thrust in airborne vehicles, aircraft, and helicopters.

The present application claims the benefit of U.S. Provisional Application Ser. No. 61/424,487, filed on Dec. 17, 2010 (pending). The disclosure of the previously filed provisional application is hereby incorporated by reference in its entirety for all purposes and made a part of the present disclosure.

### BACKGROUND OF THE INVENTION

1. Field of the Invention

The present disclosure is directed generally to a recuperator or method of operating a recuperator, and more specifically, a recuperator for use with turbine engines. More specifically, the present disclosure is directed to a low-cost recuperator that has particular applicability for micro- and mini- turbines producing either distributed power generation or thrust for light aircraft and helicopters.

2. Background of the Invention

A gas turbine engine extracts energy from a flow of hot gas produced by combustion of gas or fuel oil in a stream of compressed air. In its simplest form, a gas turbine engine has an air compressor coupled to a turbine with a combustion chamber. Energy is released and work is performed when compressed air is mixed with fuel and ignited in the combustor, directed over the turbine's blades, thereby spinning the turbine. Energy is extracted in the form of shaft power, electric power generation, and/or compressed air and thrust (e.g., turbojet/turbofan engines).

Irrespective of the exact engine type, most gas turbine engines operate in the same or similar manner. Ambient air is received at the inlet of the compressor where it is compressed and discharged at a substantially higher pressure and temperature. The compressed air then passes through the combustion chamber, where it is mixed with fuel and burned, thereby further increasing the temperature for combustion gases. The hot combustion gases are then passed through the hot turbine section, whereby mechanical shaft power may be extracted to drive a shaft, propeller or fan. Any remaining exhaust gas pressure above ambient pressure can be used to provide thrust if exhausted in a rearward direction.

Some turbine engines also recover heat from the exhaust, which is otherwise wasted energy. For instance, a recuperator is often used in association with the combustion portion of a gas turbine engine, to increase its overall efficiency. Specifically, the recuperator is a heat exchanger that transfers some of the waste heat in the exhaust to the compressed air, thus preheating it before entering the combustor. Since the compressed air has been preheated, less fuel is needed to heat the compressed air/fuel mixture up to the turbine inlet temperature. By recovering a significant amount of the energy usually lost as waste heat, the recuperator can make a gas turbine significantly more efficient.

Use of a recuperator, while improving efficiency of a gas turbine engine, can also have a number of disadvantages in various applications. One such disadvantage is the significant cost of recuperators which is about 25-30% of the total power plant cost. This share is even higher for micro-turbines. This means that the recuperator must be designed to achieve high performance with minimum cost.

A second common disadvantage stems from pressure losses that reduce the useful power of a turbine engine that includes a recuperator. Pressure losses are due to drag associated with flue gas and air flows inside a recuperator. Pressure is lower and the temperature is higher in the flue gas flow compared to those in the air flow. This results in that the air density is larger than that of flue gases by an order of magnitude. Accordingly, the flue gas velocity is higher than the air velocity. Thus, most drag losses occur in the flue gas flow through a recuperator. The pressure losses can be increased by flow non-uniformity occurring in recuperators. The uniformity results in that only a portion (around 50%) of the recuperator cross-section serves as flow passage. The reduced cross-section area causes larger pressure losses. This harmful effect further reduces the useful power of turbine system. The reduced power output is especially disadvantageous in aircraft and helicopter applications where maximum power is often desired and/or necessary during takeoff or hot and high altitude flying.

Incorporation of conventional recuperators also results in increased weight of a turbine engine. Such a disadvantage is also evident in aircraft applications where turbine engines are often utilized due to their high power to weight ratio. That is, in most cases, gas turbine engines are considerably smaller and lighter than reciprocating engines of the same power rating. For this reason, turbo-shaft engines are used to power almost all modern helicopters. Typically, incorporation of a recuperator has heretofore resulted in significant addition of weight to the turbine engine. Historically, the added weight and cost of the recuperator and associated system plumbing has more than offset any reduced fuel consumption, yielding endurance break-even times that are much too long for typical flight times. For at least these reasons, use of recuperators have not found widespread acceptance in the light aircraft and helicopter industry. However, the increased efficiency of a micro-turbine, say from 20% to 40% (hppt://www.rto.nato.int/abstractd.asp) can halve the fuel consumption and thus even reduce the total weight. For electric power generators, this disadvantage is not crucial.

### SUMMARY OF THE INVENTION

The present invention provides, in certain embodiments, a recuperator that is of low cost, but achieves high performance. Preferred embodiments also achieve uniform air and flue-gas flows in the recuperator, which allow for a reduction in pressure losses.

In one aspect of the invention, a recuperater is provided for a recuperated gas turbine engine system including a gas turbine engine having an external air compressor outlet duct exiting a compressor of the engine, an external combustor inlet duct, and an exhaust port exiting the engine. Such a recuperator includes an inlet header disposed in communication with the external air compressor outlet of the engine, an outlet header disposed in communication with the external combustor inlet of the engine, and a heat exchanger core operably positioned between the inlet and outlet headers. Further, the heat exchanger core is formed from a plurality of layers, with metal wire mesh situated between the layers and bounded by metallic sheets.

### BRIEF DESCRIPTION OF THE DRAWINGS

So that the manner in which the features and advantages of the present invention may be understood in more detail, a more particular description of the invention briefly summarized above may be had by reference to the embodiments thereof which are illustrated in the appended drawings that form a part of this specification. It is to be noted, however, that the drawings illustrate only various exemplary embodiments of the invention and are therefore not to be considered limiting of the invention's scope as it may include other effective embodiments as well.

FIG. 1 is a partial illustration of a capstone recuperator displaying thermal instability;

FIG. 2 is a simplified illustration in (a) top and (b) side views of a commercial wire mesh construction suitable for use with the present invention;

FIG. 3 is a cross-sectional view of an involute layer in an annular recuperator according to the present invention;

FIG. 4 is a simplified illustration of an air layer of recuperator, according to the invention;

FIG. 5 is a simplified cross-sectional view of an air layer according to the present invention;

FIG. 6 is a simplified cross-sectional view of a gap between two air layers, in a recuperator according to the present invention;

FIG. 7 is a simplified cross-sectional view of a heat exchanger core section in a recuperator according to the present invention;

FIG. 8 is a perspective view of a planar recuperator;

FIG. 9 is a perspective view of the annular arrangement of a heat exchanger core layer in a recuperator;

FIG. 10 is a perspective view of an annular recuperator; and

FIG. 11 is a graphical representation of the temperature distributions in a recuperator, according to the present invention.

### DETAILED DESCRIPTION OF THE PREFERRED EMBODIMENTS

Recuperators typically feature a plurality of small channels that communicate air and flue gas flows. Such a common configuration can lead to thermal instability. Referring to FIG. 1, such a capstone recuperator 110 is shown. Cold pressurized air enters layers 112 of the capstone recuperator at the right-top corner, is distributed downward, goes inside the plurality of small wavy channels from the right to the left, turns upward in the left triangular collector, and leaves the layer at the left-top corner. Hot flue gases flows between adjacent layers from the left to the right inside another plurality of small wavy channels formed by the adjacent layers.

Thus, temperature is typically at a maximum at the left side of the layer (hot end) and at a minimum at the right side of the layer (cold end). Higher temperatures is reflected in a darker coloring to the metal wall while colder temperatures do not change the initial bright gray color of the metal wall. Ideally, the temperature distributions in a recuperator should exhibit uniformity in the vertical direction and a gradual change along the horizontal direction. This should then provided a recuperator that reflect color uniformity in the vertical direction and gradually changing color in the horizontal direction, from a left region that is darkest and a right region that is bright gray.

Unfortunately, the Capstone recuperator is far from being perfect. The fact, that the lower part of the layer is dark along its entire horizontal extent, indicates that the flue gases mostly move through the lower part of the layer and do not give up a significant amount of its heat to the cold air. The cold air mostly flows through the upper part of the layer and eventually is heated up. This heat comes from the hot flue gases due to the thermal conduction through the metal wall. Since the flue gas flow, passing through the lower part of the layer, is rather remote from the airflow, passing though the upper part of the layer, the heat transfer between these flows is significantly reduced.

This imperfect heat exchange can result from the thermal instability of the vertically uniform temperature distribution. Suppose a hot spot appears at some spatial location in the layer. This spot can most probably be located in the lower part of the layer away from the cold flow inlet. Since the air viscosity together with temperature, the hot spot has its drag elevated compared with that of cooler regions. This elevated drag decelerates the air flow passing through the hot spot. In turn, this decreases the cooling effect of the air flow and the hot spot becomes hotter and wider. Moreover, the air flow, decelerated at the hot spot, becomes immediately slower along the entire horizontal extent of all wavy channels, passing through the hot spot, because the flow rate in a channel is uniform along the channel. This causes the hot spot to rapidly expands along channels.

Further, the positive feedback results in an initially small hot spot that eventually occupies a significant portion of the recuperator. The hot spot expansion is saturated as the cross-section area of the cold air passage becomes significantly reduced. As the air mass rate is fixed, the reduced area results in the air flow acceleration that compensates and overcomes the deceleration due to the instability.

FIG. 1 illustrates the temperature distribution caused by saturated thermal instability. The hot spot (dark region) HS occupies nearly the entire lower half of the layer. The color gradually changes from bright gray to dark only in the upper part of the layer. Thus only a half of the recuperator volume is efficiently used for heat exchange between the air and flue gas flows.

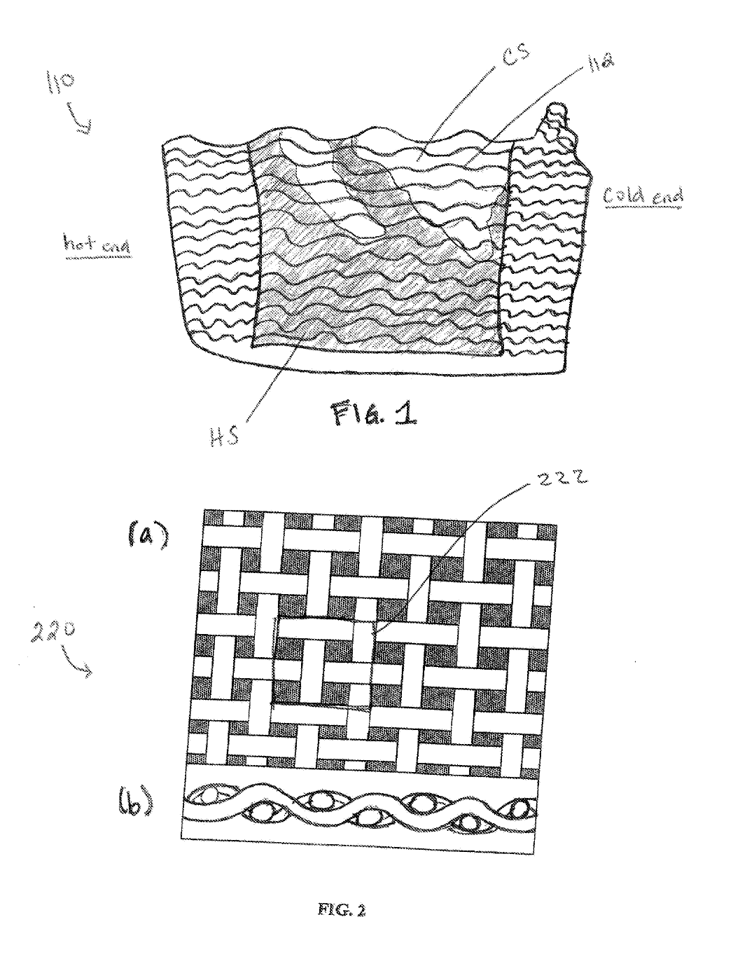

In one aspect of the present invention, a recuperator is provide that utilizes Passages of unique and different geometries to communicate air and flue gases and to suppress thermal instability. This geometry utilizes a wire mesh such as the wire mesh 220 depicted in FIG. 2. In a layer filled with a wire mesh, there is no small channel limiting the flow direction. Both air and flue gases can freely flow inside the layer directed only by a pressure gradient. Thus, if a hot spot develops, air can go around the spot, not limited by small channel walls. The air flow deceleration near the front part of the spot does not affect the flow far upstream and downstream in contrast to that inside a small channel. Moreover, as air moves around the hot spot, its velocity increases thereby intensifying the heat transfer from the air flow to the hot spot. This negative feedback cools the hot spot and suppresses thermal instability.

An additional effect of a wire mesh is increased heat conduction through the metal skeleton of a recuperator. The wire diameter is significantly larger than the wall thickness of the small channels. As an example, the wire diameter can be 1 mm and the wall thickness can be 0.1 mm. This difference especially affects the heat conduction along the normal-to-flow direction which is significantly larger in the wire-mesh recuperator than that in a conventional one. This high conduction tends to make the temperature distribution uniform in the normal-to-flow direction and thus also suppresses thermal instability.

Wire Mesh Features Suitable for Recuperators

FIG. 2 depicts a commercially available wire mesh 220 with a stainless steel wire of diameter d=1 mm. (See e.g., www.alibaba.com/product-gs/3043744/wiremesh/showimage.html). The mesh 220 is periodic in both the horizontal and vertical directions (see FIG. 2a). The lines 222 in FIG. 2 denote boundaries of one period. The period length is 5.08 d in both two tangential directions. The mesh thickness is 2.3 d (FIG. 2b). A set of the wire mesh layers pressed together constitutes a kind of porous material with a porosity (void/total volume ratio) OF 0.72. This material is well permeable for a fluid flow, i.e., for both the air and flue-gas flows in a recuperator. The high thermal conductivity of a metal and the high volume share of metal (around 30%) are favorable to suppress the thermal instability and to make the temperature uniform in the recuperator cross-section normal to the (air and flue gas) flow, as discussed above.

A recuperator that incorporates the wire mesh core structure, according to the invention, provides the above-described improved thermal performance. The material and construction cost of the inventive recuperator is also relatively low, particularly in view of the low cost and availability of the wire mesh. Furthermore, the flexibility of the wire mesh allows it to easily fill planar or even curved layers of a recuperator.

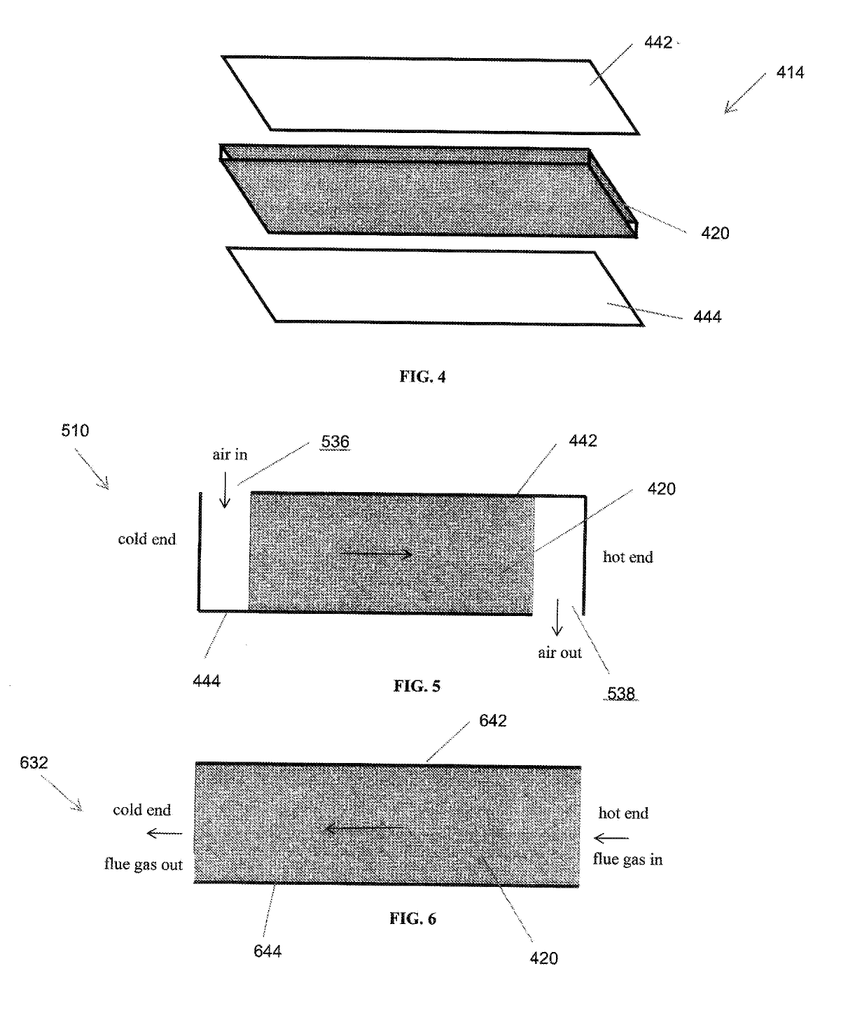

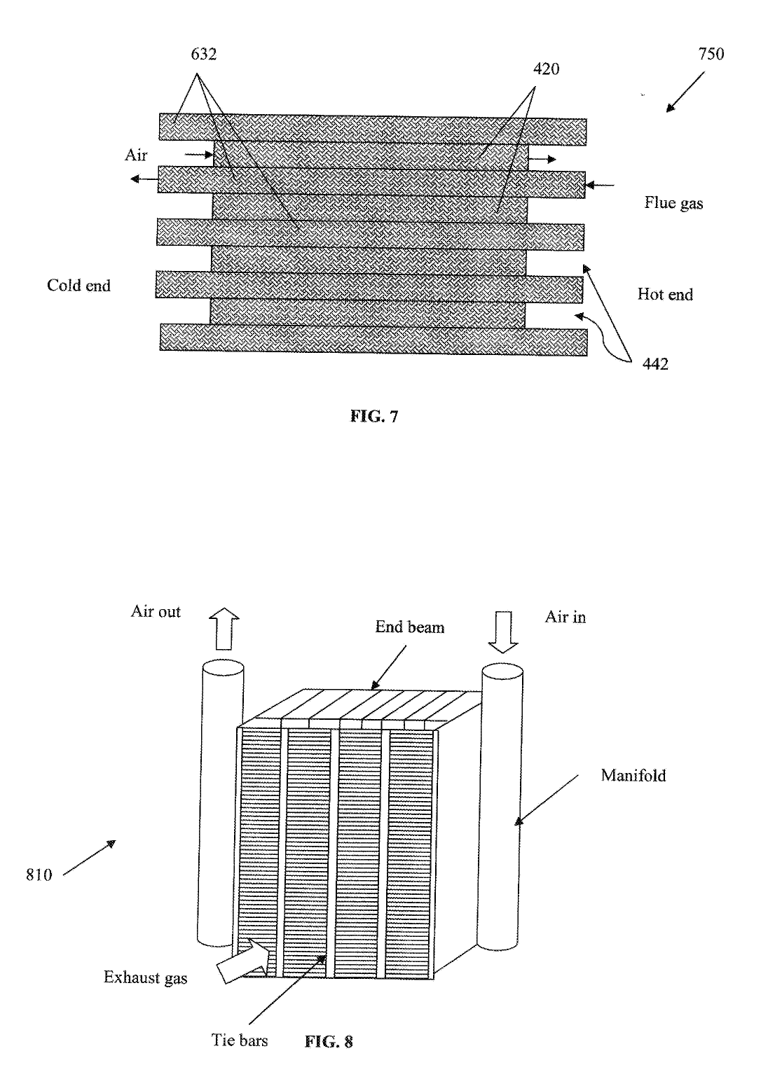

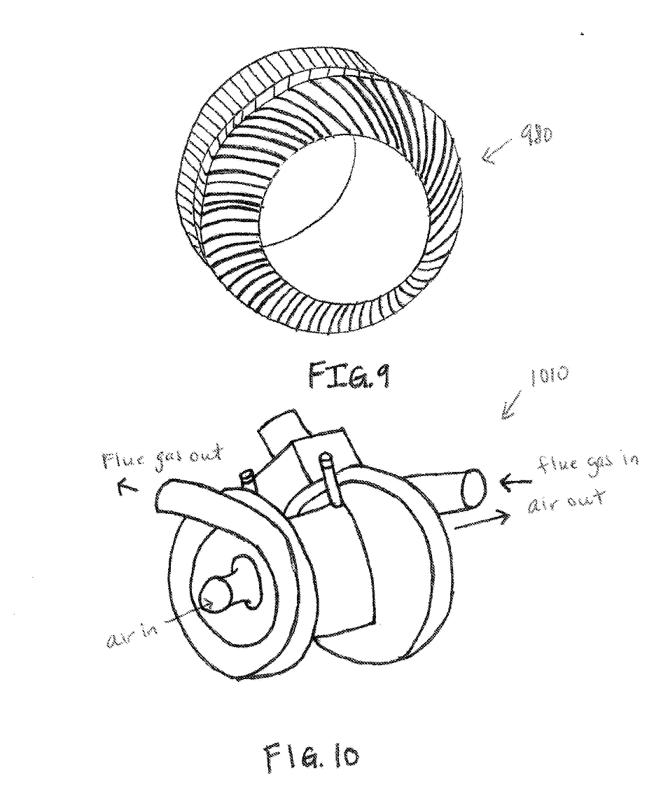

FIGS. 4-7 depict simplified illustrations of the layers that may comprise a heat exchanger core of a recuperator according to the present invention. FIG. 4 illustrates the basic construction of such a core layer 414 for air passage. The layer 414 is formed by a wire mesh construction or sheet 420 that is bounded by metal sheets 442, 444. As shown in the cross-sectional view of FIG. 5, each of the metal sheets 442, 444 is substantially welded at its interface with mesh sheet 420. The metal sheets 442, 444 extend horizontally past the wire mesh 420 on one closed end to form a channeled inlet 536 or channeled outlet 538. The core also includes gaps situated between two air layers 414, such as the gap 532 depicted in FIG. 6. Running counter to the air flow direction in the layer 414, the gap 632 communications flue gas flow from a hot end to a cold end of the recuperator.

The cross sectional view of FIG. 7 provides a core section 750 of a plurality of layers 414 and gaps 632, in a stacked arrangement. Each air layer 414 is separated by a gap 632 (also filled with mire mesh) that communicates flue gas flow. FIG. 7 also shows the air flow and flue gas flow directions with arrow indicators (which, or course, counter one another to effect efficient heat transfer). This exemplary arrangement is one example of a planar structure (or annular in the direction normal to the picture plane), according to the invention;

A recuperator according to a preferred embodiment features, therefore, a plurality of planar or curved layers filled with a metal wire mesh and bounded by thin metal sheets. Each layer serves as a channel for the pressurized air. The layers are separated by gaps also filled by wire mesh. The air flow moves from the compressor through a plurality of the layers to the combustor. The flue gas flow moves in the opposite direction from the turbine outlet through plurality of the gaps to the exhaust port of the recuperator. The recuperator may be utilized with micro-turbine engines of various applications including power and thrust generation. The recuperator is able to provide improved fuel consumption and increased endurance with minimal losses in the overall power.

In one aspect of the invention, wire mesh construction is incorporated into the recuperator core to provide a high performance recuperator having a relatively low overall mass. The recuperator design overcomes certain drawbacks of conventional recuperator, including thermal instability while also minimizing pressure loss, achieving fuel cost savings, and maintaining a low overall cost.

In one aspect, a recuperator is provided for use with a gas turbine engine having an external duct between a compressor discharge air outlet and a combustor inlet. The recuperator includes a housing, a heat exchanger core, an inlet header and an outlet header. The inlet header includes an inlet port that is connectable to the outlet of a compressor of the turbine engine. The outlet header includes an outlet port that is connectable to an external combustor inlet of the engine. A plurality of layers filled with a wire mesh defining the core extends between and fluidly interconnects the inlet and outlet headers. The housing at least partially surrounds the layers and includes an exhaust inlet port and exhaust outlet port for connection with exhaust ducting of the engine. In this regard, when the housing is interconnected to the exhaust ducting, exhaust gases are directed over and around the layers that extend between the headers. The air flow direction through the layers is substantially aligned with the flue-gas flow direction in the gaps between the layers and therefore, the recuperator is a counter-flow recuperator.

To allow for adequate mass flow through the layers and the gaps as well as adequate heat transfer between the air and flue-gas flows, the recuperator will typically incorporate more than a hundred layers. Further, in any layers arrangement, it is desirable to reduce the thickness the metal sheets bounding each layer in order to reduce the overall weight of the recuperator. In this regard, it is preferable that the sheets have a wall thickness of no more than 260 micrometers and more preferably less than about 100 micrometers.

In one arrangement, the layers are disposed in an annular region to allow exhaust gases to pass through the annulus formed by the layers. In such an arrangement, a baffle or deflector may be disposed within the annulus or at the end of the recuperator exhaust in order to deflect exhaust gases over, through and around the layers. Further, in such an arrangement, the inlet and outlet headers may have annular structures.

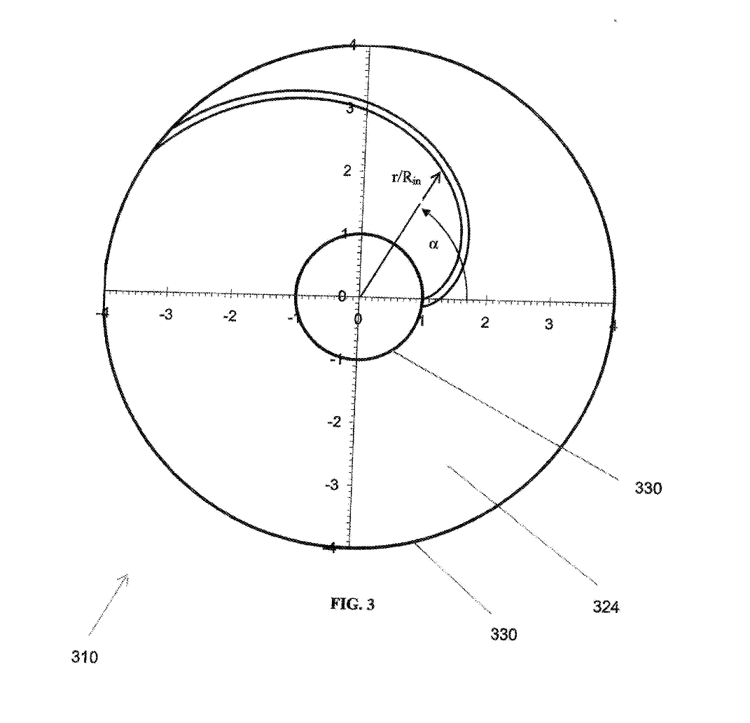

FIG. 3 depicts a recuperator 310 having an annular structure. Here, inner and outer metal sheets 330 bind a wire-mesh layer 324 to create an involute geometry. The bold circles 330 are the boundaries of the annular recuperator 310 cross-section. The bold curves are the boundaries of a layer having the involute geometry. The shape of the inner boundary 330 is governed by the relation,

α=αᵢₙ+[(r/Rᵢₙ)²−1]^{1/2}−a tan{[(r/Rᵢₙ)²−1]^{1/2}}, (1)

where α is an angle around the recuperator axis, r is the distance from the axis, Rᵢₙ the radius of the inner circle, and αᵢₙ, is the α value at r=Rᵢₙ. In FIG. 1, αᵢₙ=0 for the inner boundary. The outer boundary of the layer and boundaries of all other layers are governed by relation (1) where αᵢₙ=2πk/N, k=1, 2, . . . , N; N is the total number of the boundaries. Since each layer has two boundaries, the number of the layers is N/2 and the number of the gaps between the layers is N/2 as well. In accordance with the invention, wire mesh is substantially situated within each of the layers and each of the gaps.

FIGS. 8-10 depict basic recuperator constructions known in the art, which may and are modified to incorporate a heat exchanger core and layers of the present invention. FIG. 8 illustrates the basic construction of an upright recuperator 810 used in the prior art (i.e., a Svengska Recuperator). The recuperator 810 is modified to incorporate a heat exchanger core and planar layers, according to the invention. In this construction, the corrugated layers of the conventional core is replaced with a plurality of planar layers filled with wire mesh, as discussed above. The result is a planar recuperator according to the invention.

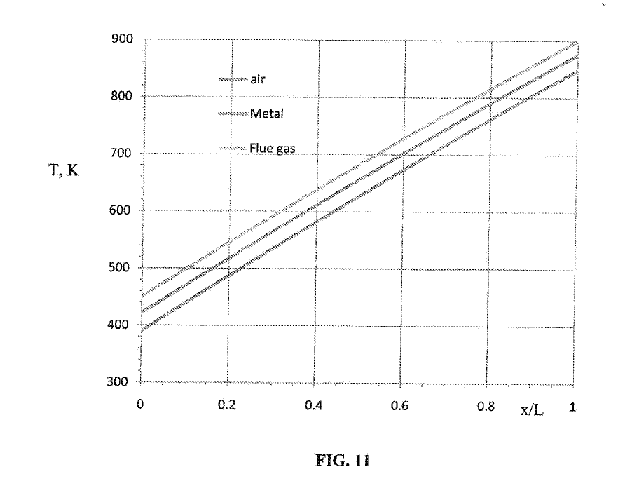

FIG. 10 depicts an annular recuperator 1010 known in the art. FIG. 9 illustrates an annular arrangement 980 of heat exchanger core layers that may be used with the recuperator 1010. The annular arrangement is one that is employed in a commercially available Solar Turbine recuperator. An annular recuperator according to the invention may incorporate such an annular arrangement and geometry, but instead of using corrugated layers, the recuperator utilizes wire-mesh annular layers. The arrangement is of course similar to the one previously described in respect to FIG. 3.

An exemplary operation of the recuperator is partly illustrated by the temperature distribution graphically represented in FIG. 11. Specifically, the temperature distribution is shown along the length (L) of the exemplary inventive recuperator. The initial temperature and pressure of the air flow are Tₐ₀=390K and Pₐ=455000 Pa. The initial temperature and pressure of the flue gas flow are T_{fgL}=900K and Pₜ=103352 Pa. There are 164 layers for air and 164 gaps for flue gases. The width (normal to the flow) of each layer and gap is 0.636 m. The length (along the flow) of each layer and gap is L=0.5 m. The wire diameter is 1 mm. The metal sheet thickness is 0.12 mm. The total mass rate is 1.05 kg/s for the air and 1.05 kg/s for the gas flow. The pressure losses are 60 Pa in the air flow, 4740 Pa in the flue gas flow, and the total losses are 4800 Pa, i.e., the total losses are less than 1.5%. The recuperator thermal efficiency is 90%.

The foregoing descriptions of various embodiments and aspects of the present invention have been presented for purposes of illustration and description. These descriptions are not intended to limit the invention to the various absorbent cores or articles, and processes disclosed. Various aspects of the invention are intended for applications other than the engine described herein. These and other variations of the invention will become apparent to one generally skilled in the relevant consumer product art provided with the present disclosure. Consequently, variations and modifications commensurate with the above teachings, and the skill and knowledge of the relevant art, are within the scope of the present invention. The embodiments described and illustrated herein are further intended to explain the best modes for practicing the invention, and to enable others skilled in the art to utilize the invention and other embodiments and with various modifications required by the particular applications or uses of the present invention.

What is claimed is:

1. In a recuperated gas turbine engine system including a gas turbine engine having an external air compressor outlet duct exiting a compressor of the engine, an external combustor inlet duct, and an exhaust port exiting the engine, a recuperator comprising:
an inlet header disposed in communication with the external air compressor outlet of the engine;
an outlet header disposed in communication with the external combustor inlet of the engine; and
a heat exchanger core operably positioned between the inlet and outlet headers, the core being formed from a plurality of layers, wherein metal wire mesh is situated between the layers and bounded by metallic sheets.

2. The recuperator of claim 1, wherein the layers are planar.

3. The recuperator of claim 1, wherein the layers include layers that are curved.

4. The recuperator of claim 1, wherein each layer forms, at least particularly, a channel for communicating pressurized air.

5. The recuperator of claim 1, wherein the layers are separated by gaps, wherein wire mesh is situated in the gaps.

6. The recuperator of claim 5, wherein the core is configured such that air flow moves from the compressor through a plurality of the layers to the combustor, and the flue gas flow moves in an opposite direction from a turbine engine outlet through a plurality of the gaps to an exhaust port of the recuperator.

7. The recuperator of claim 1, wherein said plurality of layers are stacked in a box.

8. The recuperator of claim 1, wherein said plurality of layers are stacked in an annular configuration between said inlet header and said outlet header, wherein an exhaust gas inlet port is disposed proximate to said outlet header and an exhaust gas outlet port is disposed proximate to said inlet header, said configuration surrounding the combustor and the turbine.

9. The recuperator of claim 8, wherein the wire mesh is constructed by wires having a diameter of less than about 1 mm.

10. The recuperator of claim 8, wherein each of said metal sheet has a maximum thickness of less than about 0.2 mm.

11. The recuperator of claim 8, wherein said exhaust inlet port and said exhaust outlet port are substantially aligned with a central axis of an annulus defined by an annularly formed configuration of the layers.

12. The recuperator of claim 8, wherein a pressure drop of compressed air between said inlet header and said outlet header is less than about 2%.

13. The recuperator of claim 8, wherein a pressure drop of flue gases between said inlet header and said outlet header is less than about 2%.

14. The recuperator of claim 8, wherein said recuperator has an effectiveness of at least 0.9.

15. A recuperator gas turbine system comprising:
an inlet header connected to the external air compressor outlet duct of an engine;
an outlet header connected to the external combustor inlet duct of an engine; and
a heat exchanger core formed from a plurality of layers filled with metal wire mesh and bounded by thin metal sheets.

16. The recuperator of claim 15, wherein the core further includes gaps between each pair of layers, the core being configured for air flow through the layers and flue gas flow through the gaps in a direction counter to the air flow.

17. The recuperator of claim 16, wherein the gaps includes wire mesh situated therein.

18. The recuperator of claim 17, wherein the wire mesh has a periodic configuration.

19. A method of recuperating or recovering heat from the exhaust of a gas turbine engine system, comprising the step of:
positioning a recuperator in engagement with a gas turbine system such that an inlet header is disposed in communication with the external air compressor outlet of the engine, an outlet header is disposed in communication with the external combustor inlet the engine, a heat exchanger core is operably positioned between the inlet and outlet headers, wherein the core has a plurality of layered channels with metal wire mesh; and
causing air flow to move from the compressor through the plurality of channels to the combustor, and flue gas flow to move in the opposite direction through the core from the turbine outlet, in heat exchange with the air flow.

20. The method of claim 19, wherein the step of causing air flow and flue gas flow includes causing the flue gas flow though gaps between pairs of layers and through wire mesh situated therein.
